(19) United States
(12) Patent Application Publication
(10) Pub. No.: US 2025/0286476 A1
(43) Pub. Date: Sep. 11, 2025

(54) POWER GENERATION DEVICE

(71) Applicant: TOKYO OHKA KOGYO CO., LTD., Kanagawa (JP)

(72) Inventor: Mamoru HOSOYA, Kanagawa (JP)

(21) Appl. No.: 19/072,264

(22) Filed: Mar. 6, 2025

(30) Foreign Application Priority Data
Mar. 11, 2024 (JP) 2024-037195
Feb. 19, 2025 (JP) 2025-025060

(51) Int. Cl. H02N 1/04

(52) U.S. Cl. CPC H02N 1/04

(57) ABSTRACT

Provided is a power generation device capable of facilitating electrical connection of a plurality of first electrode layers and electrical connection of a plurality of second electrode layers. A first chargeable layer 13 and a second chargeable layer 23 face each other due to parts of a plurality of first sheet members 10 and parts of a plurality of second sheet members 20 being alternately stacked, a power generation device 1 generates power by way of a change in a mutual contact state between the first chargeable layer 13 and the second chargeable layer 23, a first connecting conductor 30 penetrates through another part of each of the plurality of first sheet members 10 and is connected to a first electrode layer 12 of each of the plurality of first sheet members 10, and a second connecting conductor 40 penetrates through another part of each of the plurality of second sheet members 20 and is connected to a second electrode layer 22 of each of the plurality of second sheet members 20.

This application is based on and claims the benefit of priority from Japanese Patent Application Nos. 2024-037195 and 2025-025060, respectively filed on 11 Mar. 2024 and 19 Feb. 2025, the contents of which are incorporated herein by reference.

### BACKGROUND OF THE INVENTION

### Field of the Invention

The present invention relates to a power generation device that generates power using frictional charging.

### Related Art

As a power generation device in the related art, a power generation device including a first member that includes a first chargeable layer on a side of an outer surface of a first electrode layer and a second member that includes a second chargeable layer on a side of an outer surface of a second electrode layer is known (see Japanese Unexamined Patent Application, Publication No. 2016-500248, for example). The power generation device in the related art has a structure in which the first member and the second member are stacked such that the first chargeable layer and the second chargeable layer face each other, and generates power by changing a contact state between the first chargeable layer and the second chargeable layer.

In order to increase a power generation output of the power generation device, it has been studied to arrange, in a stacking direction, a plurality of sets each composed of a first chargeable layer and a second chargeable layer facing each other by alternately stacking a plurality of first members and a plurality of second members.
Patent Document 1: Japanese Unexamined Patent Application, Publication No. 2016-500248

### SUMMARY OF THE INVENTION

In the power generation device including the plurality of first members and the plurality of second members, the first electrode layers of the plurality of first members are connected in parallel or in series by a connecting wire, and the second electrode layers of the plurality of second members are connected in parallel or in series by a connecting wire. In this case, a state in which the connection wires are connected to the first electrode layers and the second electrode layers in advance is achieved, other members are stacked on the first electrode layers and the second electrode layers with the connecting wires connected thereto to thereby form the first members and the second members. Therefore, there is a concern that for the power generation device including the plurality of first members and the plurality of second members, an operation of connecting the connecting wires to the first electrode layers and the second electrode layers may become complicated, which may lead to an increase in manufacturing cost.

An object of the present invention is to provide a power generation device capable of facilitating electrical connection of a plurality of first electrode layers and electrical connection of a plurality of second electrode layers.

A power generation device according to the present invention includes: a plurality of first sheet members; a plurality of second sheet members; a first connecting conductor; and a second connecting conductor. Each of the first sheet members includes a first electrode layer and a first chargeable layer disposed on an outer surface of the first electrode layer, each of the second sheet members includes a second electrode layer and a second chargeable layer disposed on an outer surface of the second electrode layer, the first chargeable layer and the second chargeable layer face each other due to parts of the plurality of first sheet members and parts of the plurality of second sheet members being alternately stacked, the power generation device being configured to generate power by way of a change in a mutual contact state between the first chargeable layer and the second chargeable layer, the first connecting conductor penetrates through another part of each of the plurality of first sheet members and is connected to the first electrode layer of each of the plurality of first sheet members, and the second connecting conductor penetrates through another part of each of the plurality of second sheet members and is connected to the second electrode layer of each of the plurality of second sheet members.

The power generation device according to the present invention preferably includes: a first insulating member surrounding an outer peripheral portion of the first connecting conductor, the outer peripheral portion being located between the plurality of first sheet members; and a second insulating member surrounding an outer peripheral portion of the second connecting conductor, the outer peripheral portion being located between the plurality of second sheet members.

In the power generation device according to the present invention, it is preferable that a ratio Ti1/Ts2 between a thickness Ti1 of the first insulating member and a thickness Ts2 of the second sheet members and a ratio Ti2/Ts1 between a thickness Ti2 of the second insulating member and a thickness Ts1 of the first sheet members are each 0.8 or more and 1.2 or less.

In the power generation device according to the present invention, one of the first chargeable layer and the second chargeable layer is preferably made of polyimide with a porous structure while the other is preferably made of polyamide.

In the power generation device according to the present invention, the first connecting conductor preferably includes a pair of penetrating portions penetrating through other parts of the plurality of first sheet members in a stacking direction, and a coupling portion extending in a plane direction of the first sheet members and coupling proximal end portions of the pair of penetrating portions to each other, and the second connecting conductor preferably includes a pair of penetrating portions penetrating through other parts of the plurality of second sheet members in a stacking direction, and a coupling portion extending in a plane direction of the second sheet members and coupling proximal end portions of the pair of penetrating portions to each other.

The power generation device according to the present invention preferably includes: a first conducting wire connected to the first connecting conductor; and a second conducting wire connected to the second connecting conductor, the first conducting wire is preferably sandwiched between the coupling portion of the first connecting conductor and the first sheet member, and the second conducting wire is preferably sandwiched between the coupling portion of the second connecting conductor and the second sheet member.

In the power generation device according to the present invention, the first connecting conductor is preferably a conductive thread-shaped member with which the plurality of first sheet members are sewn together, and the second connecting conductor is preferably a conductive thread-shaped member with which the plurality of second sheet members are sewn together.

The power generation device according to the present invention preferably includes: a first conducting wire connected to the first connecting conductor; and a second conducting wire connected to the second connecting conductor, the first conducting wire is preferably sandwiched between a thread-shaped member configuring the first connecting conductor and the first sheet members, and the second conducting wire is preferably sandwiched between a thread-shaped member configuring the second connecting conductor and the second sheet members.

The power generation device according to the present invention preferably includes: spacing retention members that retain spacings between the first and second sheet members facing each other in a stacking direction. Preferably, the spacing retention members are each disposed between an end portion of the first sheet member adjacent to the second insulating member and the second sheet member facing at least one side of the end portion in the stacking direction and/or between an end portion of the second sheet member adjacent to the first insulating member and the first sheet member facing at least one side of the end portion in the stacking direction.

According to the present invention, it is possible to connect a plurality of first electrode layers to a first connecting conductor and to connect a plurality of second electrode layers to a second connecting conductor by causing the first connecting conductor to penetrate through a plurality of first sheet members in a stacking direction and causing the second connecting conductor to penetrate through a plurality of second sheet members in a stacking direction, thereby facilitating electrical connection of the plurality of first electrode layers and electrical connection of the plurality of second electrode layers.

### BRIEF DESCRIPTION OF THE DRAWINGS

FIG. 1 is a sectional view of a power generation device according to a first embodiment of the present invention;

FIG. 2 is an exploded perspective view of a first sheet member configuring the power generation device according to the first embodiment of the present invention;

FIG. 3 is an exploded perspective view of a second sheet member configuring the power generation device according to the first embodiment of the present invention;

FIG. 4 is an exploded perspective view of the power generation device according to the first embodiment of the present invention;

FIG. 5 is an exploded perspective view of a power generation device according to a second embodiment of the present invention;

FIG. 6 is a sectional view of a power generation device according to a third embodiment of the present invention;

FIG. 7 is a sectional view of a modification of the power generation device according to the third embodiment of the present invention; and

FIG. 8 is a sectional view of a modification of the power generation device according to the third embodiment of the present invention.

### DETAILED DESCRIPTION OF THE INVENTION

### First Embodiment

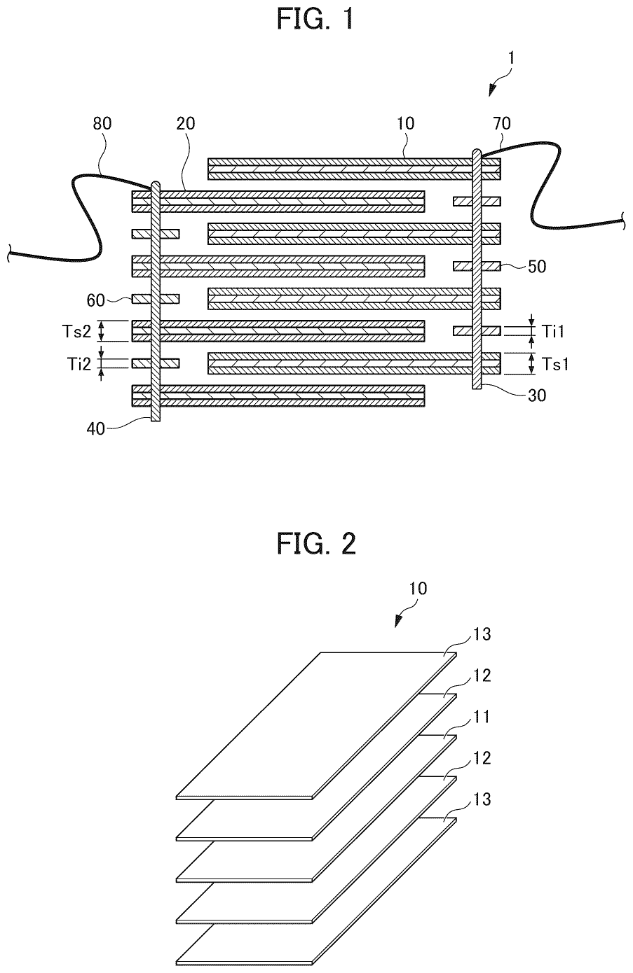

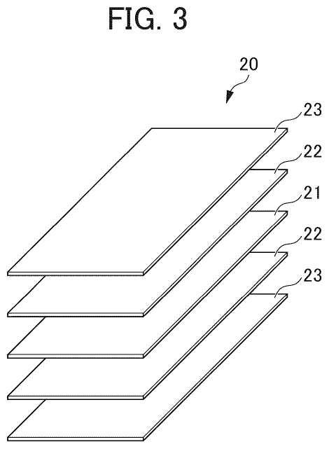

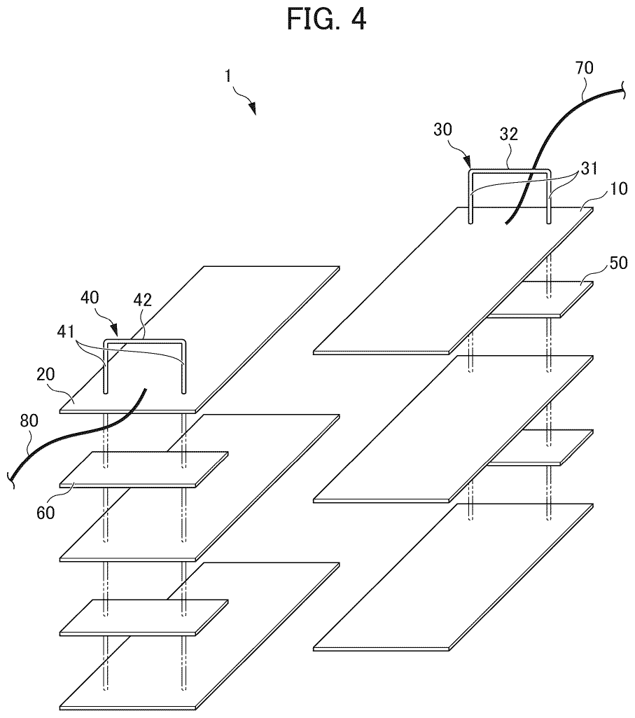

FIGS. 1 to 4 illustrate a first embodiment of the present invention. FIG. 1 is a sectional view of a power generation device, FIG. 2 is an exploded perspective view of a first sheet member configuring the power generation device, FIG. 3 is an exploded perspective view of a second sheet member configuring the power generation device, and FIG. 4 is an exploded perspective view of the power generation device.

As illustrated in FIG. 1, a power generation device 1 according to the present embodiment includes a plurality of first sheet members 10 on a positively charged side, a plurality of second sheet members 20 on a negatively charged side, a first connecting conductor 30 connected to a first electrode layer, which will be described later, of each of the plurality of first sheet members 10, a second connecting conductor 40 connected to a second electrode layer, which will be described later, of each of the plurality of second sheet members 20, a plurality of first insulating members 50 surrounding an outer peripheral portion of the first connecting conductor 30, a plurality of second insulating members 60 surrounding an outer peripheral portion of the second connecting conductor 40, a first conducting wire 70 connected to the first connecting conductor 30, and a second conducting wire 80 connected to the second connecting conductor 40.

As illustrated in FIG. 2, each of the plurality of first sheet members 10 includes a first base material layer 11, a pair of first electrode layers 12 disposed on both sides of the first base material layer 11 in a thickness direction, and a pair of first chargeable layers 13 disposed on outer sides of the pair of first electrode layers 12 in the thickness direction, respectively.

The first base material layer 11 is made of a member with an insulating property such as a polyethylene terephthalate, for example.

The pair of first electrode layers 12 are made of members with conductivity such as conductive non-woven clothes formed by depositing metal such as copper or aluminum on nonwoven clothes, copper foils, or aluminum foils, for example.

The pair of first chargeable layers 13 are made of members that have an insulating property and are charged in a polarity opposite to that of second chargeable layers, which will be described later. A material of the first chargeable layers 13 is a film-shaped member that is likely to be positively charged, such as polyamide, paper (cellulose), an aluminum foil, or a copper foil, for example. In the present embodiment, the first chargeable layers 13 are preferably made of polyamide.

As illustrated in FIG. 3, each of the plurality of second sheet members 20 includes a second base material layer 21, a pair of second electrode layers 22 disposed on both sides of the second base material layer 21 in the thickness direction, and a pair of second chargeable layers 23 disposed on outer sides of the pair of second electrode layers 22 in the thickness direction, respectively.

The second base material layer 21 is made of a member with an insulating property similar to that of the first base material layer 11.

The pair of second electrode layers 22 are made of members with conductivity similar to that of the first electrode layers 12.

The pair of second chargeable layers 23 are made of members that have an insulating property and are charged in a polarity opposite to that of the first chargeable layers 13. A material of the second chargeable layers 23 is a film-shaped member that is likely to be negatively charged, such as polyimide with a porous structure, polytetrafluoroethylene (PTFE), polystyrene, polyethylene terephthalate, or polyethylene, for example. In the present embodiment, the second chargeable layers 23 are preferably made of polyimide with a porous structure.

As illustrated in FIG. 1, the plurality of first sheet members 10 and the plurality of second sheet members 20 are stacked such that parts of them are alternately arranged. In this manner, a state where the second chargeable layers 23 of the second sheet members 20 face the first chargeable layers 13 of the plurality of first sheet members 10, respectively, is achieved.

The first connecting conductor 30 is made of a rod-shaped or plate-shaped member with conductivity such as copper or aluminum, for example. As illustrated in FIG. 4, the first connecting conductor 30 has a shape of a so-called staple used with a stapler including a pair of penetrating portions 31 that penetrate, in a stacking direction, parts of the plurality of first sheet members 10 where the second sheet members 20 are not stacked in a longitudinal direction and a coupling portion 32 that couples proximal end portions of the pair of penetrating portions 31 to each other. The stacked state of the plurality of stacked first sheet members 10 is maintained by causing the pair of penetrating portions 31 to penetrate therethrough in the stacking direction and causing the coupling portion 32 to abut on an outer surface of the first sheet member 10 located on the outermost side in the stacking direction. At this time, the plurality of first electrode layers 12 are connected in parallel to the first connecting conductor 30.

The second connecting conductor 40 is made of a member similar to that of the first connecting conductor 30. The second connecting conductor 40 includes a pair of penetrating portions 41 penetrating, in the stacking direction, through a part of each of the plurality of second sheet members 20 where the first sheet members 10 are not stacked in the longitudinal direction and a coupling portion 42 coupling proximal end portions of the pair of penetrating portions 41 to each other. The stacked state of the plurality of stacked second sheet members 20 is maintained by causing the pair of penetrating portions 41 to penetrate therethrough in the stacking direction and causing the coupling portion 42 to abut on an outer surface of the second sheet member 20 located on the outermost side in the stacking direction. At this time, the plurality of second electrode layers 22 are connected in parallel to the second connecting conductor 40.

Each of the plurality of first insulating members 50 is made of a member with an insulating property such as polyethylene terephthalate, for example, and is disposed between the plurality of first sheet members 10. The penetrating portions 31 of the first connecting conductor 30 penetrating through the plurality of first sheet members 10 penetrate through the plurality of first insulating members 50 as illustrated in FIGS. 1 and 4. In other words, each of the plurality of first insulating members 50 surrounds an outer peripheral portion of the first connecting conductor 30 located between the plurality of stacked first sheet members 10. Here, a ratio Ti1/Ts2 between the thickness Ti1 of the first insulating members 50 and the thickness Ts2 of the second sheet members 20 preferably falls within a range of 0.8 or more and 1.2 or less, and more preferably falls within a range of 0.9 or more and 1.1 or less.

Each of the plurality of second insulating members 60 is made of a member with an insulating property and is disposed between the plurality of second sheet members 20 similarly to the first insulating members 50. The penetrating portions 41 of the second connecting conductor 40 penetrating through the plurality of second sheet members 20 penetrate through the plurality of second insulating members 60 as illustrated in FIGS. 1 and 4. In other words, each of the plurality of second insulating members 60 surrounds an outer peripheral portion of the second connecting conductor 40 located between the plurality of stacked second sheet members 20. Here, a ratio Ti2/Ts1 between the thickness Ti2 of the second insulating members 60 and the thickness Ts1 of the first sheet members 10 preferably falls within a range of 0.8 or more and 1.2 or less, and more preferably falls within a range of 0.9 or more and 1.1 or less.

The first conducting wire 70 is made of a wire-shaped member with conductivity such as copper or aluminum, for example. The first conducting wire 70 is electrically connected to the first connecting conductor 30 in a state in which the first conducting wire 70 is sandwiched between an outer surface of the first sheet member 10 located on the outermost side in the stacking direction from among the plurality of stacked first sheet members 10 and the coupling portion 32 of the first connecting conductor 30.

The second conducting wire 80 is made of a member similar to that of the first conducting wire 70. The second conducting wire 80 is electrically connected to the second connecting conductor 40 in a state in which the second conducting wire 80 is sandwiched between an outer surface of the second sheet member 20 located on the outermost side in the stacking direction from among the plurality of stacked second sheet members 20 and the coupling portion 42 of the second connecting conductor 40.

The power generation device 1 configured as described above generates power by switching between a first state and a second state: in the first state, the plurality of first sheet members 10 and the plurality of second sheet members 20 alternately stacked do not receive an external force acting in a direction in which the first chargeable layers 13 and the second chargeable layers 23 are pushed against each other, whereas in the second state, the plurality of first sheet members 10 and the plurality of second sheet members 20 alternately stacked receive an external force acting in the direction in which the first chargeable layers 13 and the second chargeable layers 23 are pushed against each other.

When the power generation device 1 is in the first state, in response to the force acting in the direction in which the first chargeable layers 13 and the second chargeable layers 23 are pushed against each other, the first chargeable layers 13 are positively charged and the second chargeable layers 23 are negatively charged by the first chargeable layers 13 and the second chargeable layers 23 rubbing with each other.

When the power generation device 1 is in the second state, in response to release of the force acting in the direction in which the first chargeable layers 13 and the second chargeable layers 23 are pushed against each other, electricity flows in a direction in which potentials become the same between the first electrode layers 12 and the second electrode layers 22.

In this manner, the power generation device 1 of the present embodiment is a power generation device 1 including: the plurality of first sheet members 10; the plurality of second sheet members 20; the first connecting conductor 30; and the second connecting conductor 40, the first sheet members 10 including the first chargeable layers 13 on the outer surfaces of the first electrode layers 12, the second sheet members 20 including the second chargeable layers 23 on the outer surfaces of the second electrode layers 22, the first chargeable layers 13 and the second chargeable layers 23 facing each other due to parts of the plurality of first sheet members 10 and parts of the plurality of second sheet members 20 being alternately stacked, the power generation device 1 being configured to generate power by way of a change in a mutual contact state between the first chargeable layers 13 and the second chargeable layers 23, the first connecting conductor 30 penetrating other parts of the plurality of first sheet members 10 and being connected to the first electrode layers 12 of the plurality of first sheet members 10, and the second connecting conductor 40 penetrating through other parts of the plurality of second sheet members 20 and being connected to the second electrode layers 22 of the plurality of second sheet members 20.

In this manner, it is possible to connect the plurality of first electrode layers 12 to the first connecting conductor 30 and to connect the plurality of second electrode layers 22 to the second connecting conductor 40 by causing the first connecting conductor 30 to penetrate through the plurality of first sheet members 10 in a stacking direction and causing the second connecting conductor 40 to penetrate through the plurality of second sheet members 20 in the stacking direction, and to thereby facilitate electrical connection of the plurality of first electrode layers 12 and electrical connection of the plurality of second electrode layers 22.

Also, the power generation device 1 preferably includes: the first insulating members 50 surrounding the outer peripheral portion of the first connecting conductor 30 located between the plurality of first sheet members 10; and the second insulating members 60 surrounding the outer peripheral portion of the second connecting conductor 40 located between the plurality of second sheet members 20.

In this manner, it is possible to prevent contact between the first connecting conductor 30 and the second electrode layers 22 of the second sheet members 20, to prevent contact between the second connecting conductor 40 and the first electrode layers 12 of the first sheet members 10, and to thereby suppress short-circuiting of an electric circuit in the power generation device 1.

Preferably, the ratio Ti1/Ts2 between the thickness Ti1 of the first insulating members 50 and the thickness Ts2 of the second sheet members 20 and the ratio Ti2/Ts1 between the thickness Ti2 of the second insulating members 60 and the thickness Ts1 of the first sheet members 10 each fall within a range of 0.8 or more and 1.2 or less.

In this manner, it is possible to adjust the intervals of the adjacent first sheet members 10 to the thickness Ts2 of the second sheet members 20 with the first insulating members 50, to adjust the intervals of the adjacent second sheet members 20 to the thickness Ts1 of the first sheet members 10 with the second insulating members 60, and to thereby achieve a uniform thickness dimension over the entire power generation device 1.

Also, either the first chargeable layers 13 or the second chargeable layers 23 are preferably made of polyimide with a porous structure while the others are made of polyamide.

In this manner, it is possible to improve a power generation voltage and to further improve the amount of generated power.

Also, the first connecting conductor 30 preferably include pairs of penetrating portions 31 penetrating through other parts of the plurality of first sheet members 10 in the stacking direction and the coupling portions 32 extending in the plane direction of the first sheet members 10 and coupling the proximal end portions of the pairs of penetrating portions 31 and the second connecting conductor 40 preferably include pairs of penetrating portions 41 penetrating through other parts of the plurality of second sheet members 20 in the stacking direction and the coupling portions 42 extending in the plane direction of the second sheet members 20 and coupling the proximal end portions of the pairs of penetrating portions 41.

In this manner, it is possible to connect the plurality of first electrode layers 12 to the first connecting conductor 30 by causing the penetrating portions 31 of the first connecting conductor 30 to penetrate through the plurality of stacked first sheet members 10, to connect the plurality of second electrode layers 22 to the second connecting conductor 40 by causing the penetrating portions 41 of the second connecting conductor 40 to penetrate through the plurality of stacked second sheet members 20, and to thereby facilitate connection between the plurality of first electrode layers 12 and the first connecting conductor 30 and connection between the plurality of second electrode layers 22 and the second connecting conductor 40.

Also, the power generation device 1 preferably includes: the first conducting wire 70 connected to the first connecting conductor 30; and the second conducting wire 80 connected to the second connecting conductor 40, the first conducting wire 70 is preferably sandwiched between the coupling portion 32 of the first connecting conductor 30 and the first sheet member 10, and the second conducting wire 80 is preferably sandwiched between the coupling portion 42 of the second connecting conductor 40 and the second sheet member 20.

In this manner, it is possible to facilitate connection between the first connecting conductor 30 and the first conducting wire 70 and connection between the second connecting conductor 40 and the second conducting wire 80.

### Second Embodiment

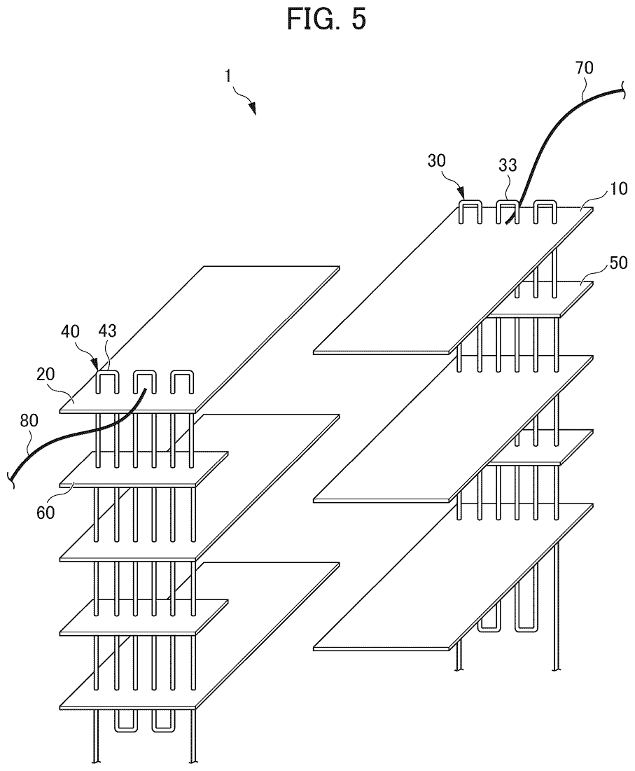

FIG. 5 illustrates a second embodiment of the present invention and is an exploded perspective view of a power generation device. Note that components similar to those in the above embodiment will be denoted by the same reference signs.

A first connecting conductor 30 and a second connecting conductor 40 forming part of a power generation device 1 according to the present embodiment are thread-shaped members 33 and 43 with which a plurality of first sheet members 10 stacked along with a plurality of first insulating members 50 and a plurality of second sheet members 20 stacked along with a plurality of second insulating members 60 are sewn together, respectively.

Each of the thread-shaped members 33 and 43 is made of a strand wire obtained by twisting a metal wire of copper or aluminum, for example, and has conductivity.

A first conducting wire 70 is electrically connected to the first connecting conductor 30 in a state in which the first conducting wire 70 is sandwiched between an outer surface of the first sheet member 10 located on the outermost side in the stacking direction from among the plurality of stacked first sheet members 10 and the thread-shaped member 33.

A second conducting wire 80 is electrically connected to the second connecting conductor 40 in a state in which the second conducting wire 80 is sandwiched between an outer surface of the second sheet member 20 located on the outermost side in the stacking direction from among the plurality of stacked second sheet members 20 and the thread-shaped member 43.

In this manner, according to the power generation device 1 of the present embodiment, it is possible to connect the plurality of first electrode layers 12 to the first connecting conductor 30 and to connect the plurality of second electrode layers 22 to the second connecting conductor 40 by causing the first connecting conductor 30 to penetrate through the plurality of first sheet members 10 in the stacking direction and causing the second connecting conductor 40 to penetrate through the plurality of second sheet members 20 in the stacking direction, and to thereby facilitate electrical connection of the plurality of first electrode layers 12 and electrical connection of the plurality of second electrode layers 22, similarly to the above embodiment.

Also, the first connecting conductor 30 is preferably conductive thread-shaped members 33 with which the plurality of first sheet members 10 are sewn together, and the second connecting conductor 40 is preferably conductive thread-shaped members 43 with which the plurality of second sheet members 20 are sewn together.

In this manner, it is possible to connect the plurality of first electrode layers 12 to the first connecting conductor 30 by sewing the plurality of stacked first sheet members 10 together with the thread-shaped member 33, to connect the plurality of second electrode layers 22 to the second connecting conductor 40 by sewing the plurality of stacked second sheet members 20 together with the thread-shaped member 43, and to thereby facilitate connection between the plurality of first electrode layers 12 and the first connecting conductor 30 and connection between the plurality of second electrode layers 22 and the second connecting conductor 40.

Also, the power generation device 1 preferably includes: the first conducting wire 70 connected to the first connecting conductor 30; and the second conducting wire 80 connected to the second connecting conductor 40, the first conducting wire 70 is preferably sandwiched between the thread-shaped member 33 configuring the first connecting conductor 30 and the first sheet member 10, and the second conducting wire 80 is preferably sandwiched between the thread-shaped member 43 configuring the second connecting conductor 40 and the second sheet member 20.

In this manner, it is possible to facilitate connection between the first connecting conductor 30 and the first conducting wire 70 and connection between the second connecting conductor 40 and the second conducting wire 80.

### Third Embodiment

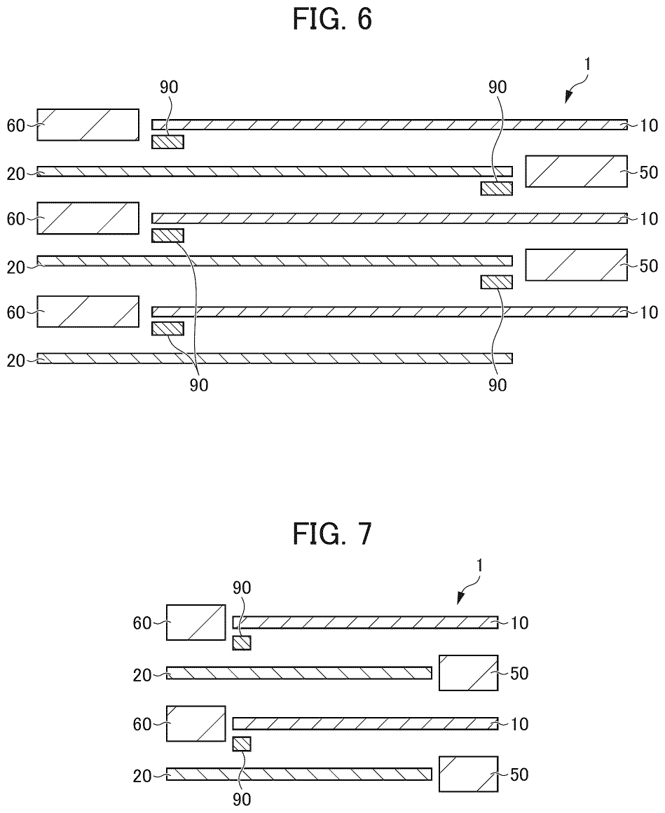

FIG. 6 illustrates a third embodiment of the present invention and is a sectional view of a power generation device. Note that components similar to those in the above embodiments will be denoted by the same reference signs.

The power generation device 1 according to the present embodiment includes first sheet members 10 and second sheet members 20 facing each other in the stacking direction, and spacing retention members 90 that retain spacings between the first and second sheet members.

Each spacing retention member 90 is a plate-shaped insulating member having a width dimension of, for example, 0.5 mm or greater and 10 mm or less and a length dimension substantially equal to the dimension in the transverse direction of the first and second sheet members 10 and 20. Each spacing retention member 90 has a thickness dimension of, for example, one-half or less of the thickness dimension of the first insulating member 50 and the thickness dimension of the second insulating member 60.

The spacing retention members 90 include spacing retention members 90 each of which is disposed between an end portion of the first sheet member 10 adjacent to the second insulating member 60 and the second sheet member 20 facing one side of the end portion in the stacking direction, and spacing retention members 90 each of which is disposed between an end portion of the second sheet member 20 adjacent to the first insulating member 50 and the first sheet member 10 facing one side of the end portion in the stacking direction. Each spacing retention member 90 is fixed to the one side of the end portion of the first sheet member 10 adjacent to the second insulating member 60 or the one side of the end portion of the second sheet member 20 adjacent to the first insulating member 50.

In the first state in which an external force is not acting in a direction in which the first chargeable layers 13 and the second chargeable layers 23 are pushed against each other, the spacing retention members 90 of the power generation device 1 having the above described configuration restrict contact between the end portion of the first sheet member 10 adjacent to the second insulating member 60 and the second sheet member 20 facing the one side of the end portion in the stacking direction and contact between the end portion of the second sheet member 20 adjacent to the first insulating member 50 and the first sheet member 10 facing the one side of the end portion in the stacking direction.

Thus, likewise to the above-described embodiments, the power generation device 1 of the present embodiment makes it possible to connect the plurality of first electrode layers 12 to the first connecting conductor 30 and to connect the plurality of second electrode layers 22 to the second connecting conductor 40 by causing the first connecting conductor 30 to penetrate through the plurality of first sheet members 10 in the stacking direction and causing the second connecting conductor 40 to penetrate through the plurality of second sheet members 20 in the stacking direction, thereby facilitating electrical connection of the plurality of first electrode layers 12 and electrical connection of the plurality of second electrode layers 22, similarly to the above embodiment.

Preferably, the power generation device 1 of the present embodiment includes the spacing retention members 90 that retain the spacings between the first and second sheet members 10 and 20, and the spacing retention members 90 include spacing retention members 90 each of which is disposed between the end portion of the first sheet member 10 adjacent to the second insulating member 60 and the second sheet member 20 facing one side of the end portion in the stacking direction, and spacing retention members 90 each of which is disposed between the end portion of the second sheet member 20 adjacent to the first insulating member 50 and the first sheet member 10 facing one side of the end portion in the stacking direction.

In the first state in which an external force is not acting in the direction in which the first chargeable layers 13 and the second chargeable layers 23 are pushed against each other, the above configuration restricts contact between the end portion of the first sheet member 10 adjacent to the second insulating member 60 and the second sheet member 20 facing the one side of the end portion in the stacking direction and contact between the end portion of the second sheet member 20 adjacent to the first insulating member 50 and the first sheet member 10 facing the one side of the end portion in the stacking direction, whereby the first chargeable layers 13 and the second chargeable layers 23 that are in an charged state are less likely to be released from the charged state.

The third embodiment has been described to have the configuration in which the spacing retention members 90 include spacing retention members 90 each of which is disposed between the end portion of the first sheet member 10 adjacent to the second insulating member 60 and the second sheet member 20 facing one side of the end portion in the stacking direction, and spacing retention members 90 each of which is disposed between the end portion of the second sheet member 20 adjacent to the first insulating member 50 and the first sheet member 10 facing one side of the end portion in the stacking direction. However, the present invention is not limited to this configuration. It is sufficient that the spacing retention members 90 are each disposed between the end portion of the first sheet member 10 adjacent to the second insulating member 60 and the second sheet member 20 facing at least one side of the end portion in the stacking direction and/or between the end portion of the second sheet member 20 adjacent to the first insulating member 50 and the first sheet member 10 facing at least one side of the end portion in the stacking direction.

As illustrated in FIG. 7, the power generation device 1 may include the spacing retention members 90 each of which is disposed only between the end portion of the first sheet member 10 adjacent to the second insulating member 60 and the second sheet member 20 facing one side of the end portion in the stacking direction. The power generation device 1 having this configuration can improve power generation efficiency in comparison with a power generation device that does not include the spacing retention members 90.

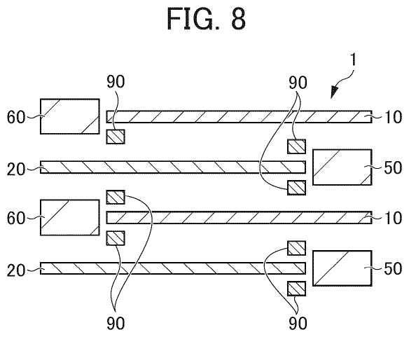

As illustrated in in FIG. 8, the spacing retention members 90 of the power generation device 1 may include spacing retention members 90 disposed between the end portion of the first sheet member 10 adjacent to the second insulating member 60 and the second sheet members 20 respectively facing the opposite sides of the end portion in the stacking direction, and spacing retention members 90 disposed between the end portion of the second sheet member 20 adjacent to the first insulating member 50 and the first sheet members 10 respectively facing the opposite sides of the end portion in the stacking direction. The power generation device 1 having this configuration can restrict contact between the end portion of the first sheet member 10 adjacent to the second insulating member 60 and the second sheet members 20 respectively facing the opposite sides of the end portion in the stacking direction, and contact between the end portion of the second sheet member 20 adjacent to the first insulating member 50 and the first sheet members 10 respectively facing the opposite sides of the end portion in the stacking direction, thereby making it possible to achieve further improved power generation efficiency.

Hereinafter, results of a power generation test performed on each of the power generation device 1 not including the spacing retention members 90 and the power generation devices 1 including the spacing retention members 90 illustrated in FIGS. 6 to 8 will be described.

The power generation test was performed using a vertical presser and an oscilloscope.

The vertical presser includes an air cylinder that is driven by compressed air.

The air cylinder includes a piston rod the tip end of which is provided with a pressing part that applies a compressive force in the thickness direction of the power generation device 1. The pressing part has a square flat surface having each side of 30 mm.

The air cylinder fixed to the main body of the vertical presser was in a posture in which its axial direction was along the vertical direction and the pressing part was oriented downward. In a state in which the power generation device 1 was disposed below the pressing part, the air cylinder of the vertical presser is driven, so that the pressing part applied a load of 16 kg to the power generation device 1, and the application of the load was released 0.3 seconds after the start of the application of the load.

In the power generation test, a voltage at the start of the application of the load to the power generation device 1 by the vertical presser and a voltage at the release of the application of the load were measured by the oscilloscope, and the power generation output per one second was calculated by the following equation.

$$P = \frac{{\int }_{0}^{1} {V ( t )}^{2} dt}{R} \qquad [ Formula 1 ]$$

In the above equation, P is a power generation output (W), V is a measured voltage (V), R is a probe resistance (Ω) of the oscilloscope, and t is a measurement time at the time of power generation.

The results of the power generation test were as follows. The power generation output of the power generation device 1 without the spacing retention members 90 was 174 μW. On the other hand, the power generation output of the power generation device 1 including the spacing retention members 90 arranged as illustrated in FIG. 6 was 699 μW. The power generation output of the power generation device 1 including the spacing member 90 arranged as illustrated in FIG. 7 was 385 μW. The power generation output of the power generation device 1 including the spacing retention members 90 arranged as illustrated in FIG. 8 was 731 μW. That is, the power generation test demonstrated that the power generation output of each of the power generation devices 1 including the spacing retention members 90 illustrated in FIGS. 6 to 8 was higher than that of the power generation device 1 not including the spacing retention member 90.

### EXPLANATION OF REFERENCE NUMERALS

1 Power generation device
10 First sheet member
12 First electrode layer
13 First chargeable layer
20 Second sheet member
22 Second electrode layer
23 Second chargeable layer
30 First connecting conductor
31 Penetrating portion
32 Coupling portion
33 Thread-shaped member
40 Second connecting conductor
41 Penetrating portion
42 Coupling portion
43 Thread-shaped member
50 First insulating member
60 Second insulating member
70 First conducting wire
80 Second conducting wire
90 Spacing retention member

What is claimed is:

1. A power generation device comprising:
a plurality of first sheet members;
a plurality of second sheet members;
a first connecting conductor; and
a second connecting conductor,
each of the first sheet members comprising a first electrode layer and a first chargeable layer disposed on an outer surface of the first electrode layer,
each of the second sheet members comprising a second electrode layer and a second chargeable layer disposed on an outer surface of the second electrode layer,
the first chargeable layer and the second chargeable layer facing each other due to parts of the plurality of first sheet members and parts of the plurality of second sheet members being alternately stacked,
the power generation device being configured to generate power by way of a change in a mutual contact state between the first chargeable layer and the second chargeable layer,
the first connecting conductor penetrating through another part of each of the plurality of first sheet members and being connected to the first electrode layer of each of the plurality of first sheet members,
the second connecting conductor penetrating through another part of each of the plurality of second sheet members and being connected to the second electrode layer of each of the plurality of second sheet members.

2. The power generation device according to claim 1, comprising:
a first insulating member surrounding an outer peripheral portion of the first connecting conductor, the outer peripheral portion being located between the plurality of first sheet members; and
a second insulating member surrounding an outer peripheral portion of the second connecting conductor, the outer peripheral portion being located between the plurality of second sheet members.

3. The power generation device according to claim 2, wherein
a ratio Ti1/Ts2 between a thickness Ti1 of the first insulating member and a thickness Ts2 of the second sheet members and a ratio Ti2/Ts1 between a thickness Ti2 of the second insulating member and a thickness Ts1 of the first sheet members are each 0.8 or more and 1.2 or less.

4. The power generation device according to claim 1, wherein
one of the first chargeable layer and the second chargeable layer is made of polyimide with a porous structure while the other is made of polyamide.

5. The power generation device according to claim 1, wherein
the first connecting conductor comprises
a pair of penetrating portions penetrating through other parts of the plurality of first sheet members in a stacking direction, and
a coupling portion extending in a plane direction of the first sheet members and coupling proximal end portions of the pair of penetrating portions to each other, and
the second connecting conductor comprises
a pair of penetrating portions penetrating through other parts of the plurality of second sheet members in a stacking direction, and
a coupling portion extending in a plane direction of the second sheet members and coupling proximal end portions of the pair of penetrating portions to each other.

6. The power generation device according to claim 5, comprising:
a first conducting wire connected to the first connecting conductor; and
a second conducting wire connected to the second connecting conductor, wherein
the first conducting wire is sandwiched between the coupling portion of the first connecting conductor and the first sheet member, and
the second conducting wire is sandwiched between the coupling portion of the second connecting conductor and the second sheet member.

7. The power generation device according to claim 1, wherein
the first connecting conductor is a conductive thread-shaped member with which the plurality of first sheet members are sewn together, and
the second connecting conductor is a conductive thread-shaped member with which the plurality of second sheet members are sewn together.

8. The power generation device according to claim 7, comprising:
a first conducting wire connected to the first connecting conductor; and
a second conducting wire connected to the second connecting conductor, wherein
the first conducting wire is sandwiched between a thread-shaped member configuring the first connecting conductor and the first sheet member, and
the second conducting wire is sandwiched between a thread-shaped member configuring the second connecting conductor and the second sheet member.

9. The power generation device according to claim 2, comprising:
spacing retention members that retain spacings between the first and second sheet members facing each other in a stacking direction, wherein
the spacing retention members are each disposed between an end portion of the first sheet member adjacent to the second insulating member and the second sheet member facing at least one side of the end portion in the stacking direction and/or between an end portion of the second sheet member adjacent to the first insulating member and the first sheet member facing at least one side of the end portion in the stacking direction.
